(19) United States
(12) Patent Application Publication
(10) Pub. No.: US 2025/0271201 A1
(43) Pub. Date: Aug. 28, 2025

(54) DOMESTIC COOLING DEVICE HAVING A PLATE-LIKE SEPARATION UNIT CONFIGURED IN A STORAGE COMPARTMENT

(71) Applicant: BSH Hausgeräte GmbH, München (DE)

(72) Inventors: Kaan KABAKLAR, Tekirdag (TR); Ashish MODI, Istanbul (TR)

(21) Appl. No.: 19/056,829

(22) Filed: Feb. 19, 2025

(30) Foreign Application Priority Data
Feb. 23, 2024 (TR) 2024/002195

(51) Int. Cl. F25D 23/06; F21V 23/00; F21W 131/305; F25D 27/00

(52) U.S. Cl. CPC F25D 23/069; F21V 23/002; F25D 23/067; F25D 27/00; F21W 2131/305; F25D 2400/40

(57) ABSTRACT

A domestic cooling device contains a body, a storage compartment encircled by the body and foods to be cooled can be placed, and a plate-like separation unit arranged in a removable manner in the storage compartment for separation of the volume of the storage compartment and which essentially has a planar base plate. A module carrier assembly is provided which is configured to carry a function module on the plate-like separation unit, particularly to carry a light module. In the domestic cooling device, the module carrier assembly contains a module carrier body which has a longitudinal light module channel arranged such that the light module shall be positioned therein, and an external auxiliary carrier element is embodied in a manner providing passage of at least one light module cable which carries electricity to the light module, and which can be connected to the module carrier body in a removable manner.

### CROSS-REFERENCE TO RELATED APPLICATION

This application claims the priority, under 35 U.S.C. § 119, of Turkish Patent Application TR 2024/002195, filed Feb. 23, 2024; the prior application is herewith incorporated by reference in its entirety.

### FIELD AND BACKGROUND OF THE INVENTION

The present invention relates to a domestic cooling device where a module carrier assembly exists.

Domestic cooling devices, particularly refrigerators have a storage compartment wherein the foods to be cooled can be placed. There can be at least one plate-like separation unit arranged in a removable manner in the receiving space of the storage compartment. The plate-like separation unit is also arranged for separation of the volume of the storage compartment. The separation unit contains a base plate. Such base plates are also used as a placement plate where objects like food can be placed at the upper side thereof. These base plates are moreover multi-functional units, in this context, these can be used in various manners.

In the patent document numbered KR 102318549 B1, corresponding to U.S. Pat. Nos. 9,793,763, 10,139,155, 10,312,737, 10,340,741, 10,886,785, 11,239,702, 11,532,954, a refrigerator is disclosed which can illuminate the inner space in an equal manner. This application relates to a refrigerator containing a storage chamber at a predetermined size. In the refrigerator, there is a shelf containing a light source assembled to the storage chamber and embodied to illuminate the storage chamber. In the refrigerator, moreover, there is a transmitter unit connected to an external power supply and embodied to transmit the power in a wireless manner and which has a primary resonance frequency at a predetermined range, and a receiver unit embodied to get power from the transmitter in a wireless manner and to provide this to the light source unit of the shelf.

### SUMMARY OF THE INVENTION

The invention provides an additional improvement, an additional advantage or an alternative to the prior art.

The object of the invention is to provide a domestic cooling device which has a plate-like separation unit provided in the storage compartment and which has a functional module carrier assembly which is easy-to-produce and which has low-cost.

The invention, to achieve the abovementioned purpose, is a domestic cooling device containing a body, a storage compartment encircled by the body and wherein the foods to be cooled can be placed, and a plate-like separation unit arranged in a removable manner in the storage compartment for separation of the volume of the storage compartment and which essentially has a planar base plate, and where a module carrier assembly is provided which is configured to carry a function module on the plate-like separation unit, particularly to carry a light module. In the domestic cooling device, the module carrier assembly contains a module carrier body which has a longitudinal light module channel arranged such that the light module shall be positioned therein, and an external auxiliary carrier element embodied in a manner providing passage of at least one light module cable which carries electricity to the light module, and which can be connected to the module carrier body in a removable manner. By means of this, the light module cable can be carried to the light module in a safe manner. Moreover, the light module cable and the electrical socket, connected to the light module cable, are hidden such that the electrical elements like connector are not seen from outside. This provides aesthetically improving the plate-like separation unit which has functional structure. Also, since the auxiliary carrier element can be connected to the module carrier body in a removable manner, an easily reachable structure is provided when necessary (for instance, for maintenance). Moreover, the module carrier body and the removable auxiliary carrier element can be easily adapted to cooling devices which have plate-like separation unit with different widths. In other words, the module carrier body and the removable auxiliary carrier element can be easily scaled in accordance with cooling devices with different widths and can be produced easily and with low cost in a compliant manner.

Here, the “domestic cooling device” inscription is any device, particularly a refrigerator which is used in houses and which has a cooling cycle and which can realize cooling function.

Here, the “storage compartment” inscription can mean a volume wherein the foods to be cooled can be placed, particularly a cooling compartment.

Here, the “base plate” inscription can mean a plate structure which has at least planar surfaces, a glass plate structure made particularly of glass or glass ceramic material.

Here, the “plate-like separation unit” inscription can mean a separator unit containing a plate structure which at least has the planar surfaces and which functions as a separator wall dividing the storage compartment into more than one volume.

Here, the “light module cable” inscription can mean an electrical cable which carries electricity to at least the light module. Electrical tools like electrical connector, socket can be connected to the end parts of said electrical cable.

Here, the “module carrier body” can mean a support body part configured to carry at least the light module.

Here, the “auxiliary carrier element” inscription can mean a carrier element configured to carry and guide at least one light module cable and which can be connected to the module carrier body in a removable manner.

In a possible embodiment of the invention, the auxiliary carrier element contains a longitudinal channel which has a cable passage opening through which the light module cable passes and which is opened to the module carrier body from one side. By means of this, the light module cable reaches the module carrier body where the light module is positioned.

Here, the “longitudinal channel” inscription means a channel provided in the longitudinal direction of the auxiliary carrier element. The longitudinal channel can be defined by means of a base and mutual lateral walls. Again the upper part of the longitudinal channel can be open or can be covered by an upper wall.

Here, the “cable passage opening” inscription means an opening, a hole or a channel provided in a manner allowing passage of the cable.

In a possible embodiment of the invention, the module carrier body comprises at least one holding wall embodied such that the auxiliary carrier element can be held at a side which is adjacent to the light module channel, and the auxiliary carrier element has holding channels provided in a manner corresponding to the holding walls. By means of this, the auxiliary carrier element is easily retained to the module carrier body, and the auxiliary carrier element can be easily removed from the module carrier body when required. Moreover, the auxiliary carrier element can be slid in a sliding direction.

Here, the “holding walls” can essentially be provided in a form which is similar to L-shape, and the holding channels can be configured to be able to held to at least one edge part of said holding walls.

In a possible embodiment of the invention, the auxiliary carrier element is arranged in a manner extending along a width direction of the holding walls, in order to provide sliding thereof in a sliding direction on the holding walls. By means of this, while the auxiliary carrier element is being slid in the sliding direction on the holding walls, the undesired separation of the auxiliary carrier element from the holding walls is prevented.

In a possible embodiment of the invention, the auxiliary carrier element contains a connection extension which extends essentially in a parallel direction with respect to the sliding direction where the auxiliary carrier element is slid on the holding walls, and in a case where the auxiliary carrier element is connected to the module carrier body and extending on the connection extension essentially in an orthogonal direction to the connection extension, there is a connection tab provided in a manner corresponding to a connection housing provided on the module carrier body. By means of this, the auxiliary carrier element is connected to the module carrier body without needing an additional connection element. Also the auxiliary carrier element can be separated from the module carrier body without needing to use an additional tool, for instance, a screwdriver.

In a possible embodiment of the invention, the auxiliary carrier element contains a channel defining wall embodied in a manner defining the first holding channel, and the channel defining wall has a horizontal connection extension provided in a manner engaging to a longitudinal connection channel embodied on the module carrier body, and in a manner sliding in the connection channel in a condition where the auxiliary carrier element is moved in the sliding direction. By means of this, probable movement irregularities, for instance, yawing is prevented during the movement of the auxiliary carrier element in the sliding direction, and the sliding movement is brought into a more stable and balanced form.

In a possible embodiment of the invention, the second holding wall is configured to define a cable passage channel for reaching of the light module cable, which passes through the cable passage opening, to the light module channel, and there is an intermediate space in a manner corresponding to the cable passage opening between the first holding wall and the second holding wall for reaching of the light module cable to the cable passage channel through the longitudinal channel. By means of this, the auxiliary carrier element is held to the module carrier body in a balanced manner in the height direction, and at the same time, the light module cable, which passes through the longitudinal channel, reaches to the module carrier body.

In a possible embodiment of the invention, the auxiliary carrier element contains a bulged wall part which is adjacent to the cable passage opening and provided in a manner guiding the light module cable to the cable passage opening. By means of this, the light module cable is facilitated to be guided to the cable passage opening.

In a possible embodiment of the invention, the auxiliary carrier element has a casing part provided at a side which is opposite to the side where the connection extension which has the connection tab, is existing and embodied such that an electrical socket to which an end of the light module cable is connected can be placed. By means of this, the auxiliary carrier element is configured to carry also the electrical socket connected to the light module cable.

In a possible embodiment of the invention, the casing part comprises a socket casing wall provided such that the electrical socket, to which an end of the light module cable is connected, can be rested. By means of this, the electrical socket is prevented from entering into the longitudinal channel.

In a possible embodiment of the invention, there is at least one stopper extension embodied at a channel input of the longitudinal channel which is close to the casing part and shaped and dimensioned in a manner allowing passage of the light module cable but in a manner preventing passage of the electrical socket. By means of this, passage of the light module cable is allowed, but entry of the electrical socket into the longitudinal channel is additionally prevented.

In a possible embodiment of the invention, the module carrier body contains a longitudinal module carrier body channel which is adjacent to the light module channel and which extends essentially parallel to the light module channel. By means of this, a reinforced module carrier body is provided which has a light module channel.

In a possible embodiment of the invention, in the module carrier assembly, there are end caps which can be retained in a removable manner to the mutual end parts of the module carrier body channel from one side and of the cable passage channel from the other side and shaped and dimensioned in a manner providing at least partially covering the mutual end parts of the module carrier body. By means of this, the end parts of the module carrier body are aesthetically covered.

In a possible embodiment of the invention, each of the end caps contains a curved extension shaped and dimensioned in accordance with the cable passage channel, and in a condition where the related end cap is retained to the related end part of the cable passage channel, there is a lateral opening, provided for reaching the light module cable to the light module channel, at a side of the curved extension facing the light module channel. By means of this, the end parts of the module carrier body are covered aesthetically in a manner not seen from outside, and at the same time, the end caps prevent reaching of the light module cable to the light module.

In a possible embodiment of the invention, in order to fix the module carrier assembly to a lower planar surface of the base plate, at least one adhesive element is provided between the lower planar surface and a module carrier planar surface of the module carrier body facing the lower planar surface. By means of this, the module carrier assembly is fixed to the base plate. Here, the adhesive element can be any adhesive element which is solid or liquid-based. Preferably, the adhesive element can be an adhesive band, particularly a double-sided adhesive band.

In this context, the module carrier body has an extrusion profile structure made by means of an extrusion method. The module carrier body can be made of a plastic material, particularly an acrylonitrile butadiene styrene (ABS) material.

In this context, the auxiliary carrier element can be made of a plastic material, particularly an acrylonitrile butadiene styrene (ABS) material.

In this context, the end caps can be made of a plastic material, particularly acrylonitrile butadiene styrene (ABS) or polypropylene (PP) material.

In this context, the light module casing can be made of a plastic glass material, particularly a non-transparent plexy material, for instance, polymethyl methacrylate (PMMA) material.

In this context, with the indications “ceiling”, “bottom”, “upper”, “lower”, “front”, “rear”, “horizontal”, “vertical”, “upwards”, “downwards”, “inner”, “outer”, “inwardly”, “outwardly” etc. the positions and orientations given for intended use and intended arrangement of the domestic cooling device and for a user then standing in front of the domestic cooling device in a closed position of the door and viewing in the direction of the domestic cooling device are indicated.

Each possible embodiment disclosed in this text can be combined with the other possible embodiments disclosed in this text if there is no any technical constraint.

Other features which are considered as characteristic for the invention are set forth in the appended claims.

Although the invention is illustrated and described herein as embodied in a domestic cooling device having a plate-like separation unit configured in a storage compartment, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, isometric view of a domestic cooling device containing a plate-like separation unit which has a subject matter module carrier assembly;

FIG. 2 is an isometric view of the plate-like separation unit which has the subject matter module carrier assembly;

FIG. 3 is an isometric view of the subject matter module carrier assembly, in a condition where the auxiliary carrier element is assembled to the module carrier body;

FIG. 4 is another isometric view of the subject matter module carrier assembly, in a condition where the auxiliary carrier element is assembled to the module carrier body;

FIG. 5 is another isometric view of the subject matter module carrier assembly, in a condition where the auxiliary carrier element is not assembled to the module carrier body;

FIG. 6 is an exploded, isometric view where all parts that exist on the module carrier assembly are shown;

FIG. 7 is an isometric view of the auxiliary carrier element;

FIG. 8 is another isometric view of the auxiliary carrier element;

FIG. 9 is a top view of the auxiliary carrier element;

FIG. 10 is a top cross-sectional view of the module carrier assembly, in case the end caps are not retained to the module carrier body;

FIG. 11 is another top cross-sectional view of the module carrier assembly, in case the end caps are not retained to the module carrier body; and

FIG. 12 is an isometric view of another embodiment of the auxiliary carrier element.

### DETAILED DESCRIPTION OF THE INVENTION

In this detailed explanation, the invented subject matter is explained with examples in order to make the subject more understandable without forming any restrictive effect.

Within this context, the “width direction x” describes a width direction of a domestic cooling device 1, a body 2, a storage compartment 3, a plate-like separation unit 6, a base plate 8, a module carrier assembly 15, a module carrier body 16, end caps 18, 19, a light module 22 and an auxiliary carrier element 24.

Within this context, the “depth direction y” describes a depth direction of the domestic cooling device 1, the body 2, the storage compartment 3, the plate-like separation unit 6, the base plate 8, the module carrier assembly 15, the module carrier body 16, the end caps 18, 19, the light module 22 and the auxiliary carrier element 24.

Within this context, the “height direction z” describes a depth direction of the domestic cooling device 1, the body 2, the storage compartment 3, the plate-like separation unit 6, the base plate 8, the module carrier assembly 15, the module carrier body 16, the end caps 18, 19, the light module 22 and the auxiliary carrier element 24.

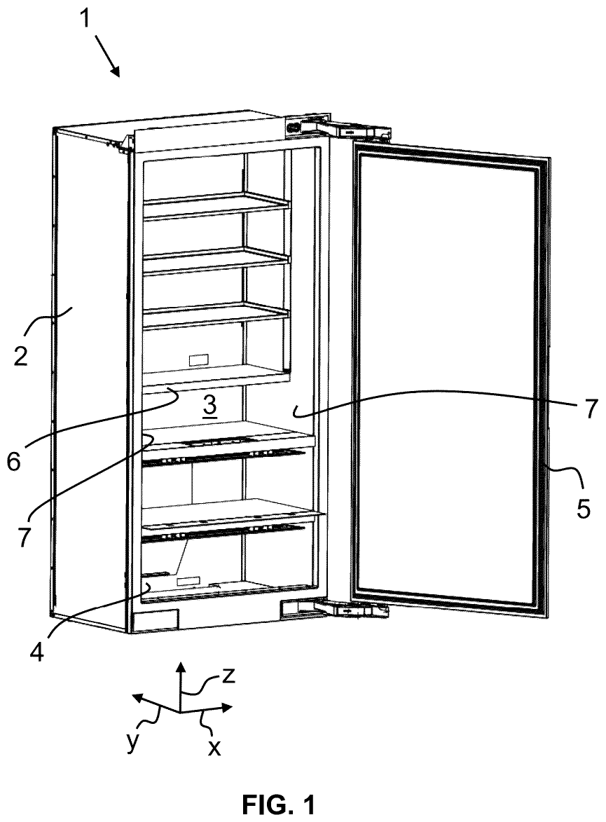

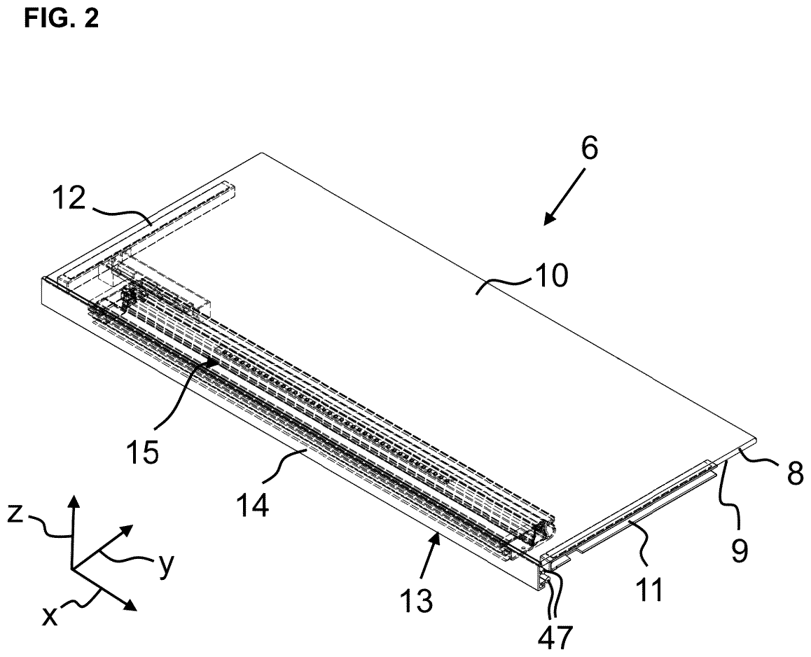

Referring now to the figures of the drawings in detail and first, particularly to FIG. 1 thereof, there is shown a domestic cooling device 1 which has a body 2 which has a lower wall, an upper wall, lateral walls and a rear wall. The body 2 is provided in a manner encircling at least one storage compartment 3 which has a receiving space wherein objects/foods to be cooled can be placed. At a device front side of the domestic cooling device 1, there is a front opening 4 in a manner providing access to the storage compartment 3 from outside. The front opening 4 is provided at an opposite side of the rear wall of the body 2. The domestic cooling device 1 moreover has at least one door 5 connected to the body 2 in a manner rotatable by means of hinges. At a closed position where the door 5 is closed, the front opening 4 is completely closed and access to the storage compartment 3 from outside is prevented. As seen in FIG. 1, in an open position where the door 5 is at least partially open, access to the storage compartment 3 from the front opening 4 can be provided. On the other hand, the body 2 moreover has mutual inner lateral walls 7 which face the storage compartment 3. In order to separate the volume of the storage compartment 3 as a lower volume and an upper volume, there is a plate-like separation unit 6 arranged in the storage compartment 3 in a removable manner and which essentially has a planar base plate 8 (see FIG. 2). The plate-like separation unit 6 can be a separator unit which functions as a separator wall inside the storage compartment 3. The plate-like separation unit 6 is provided in a manner holding to the inner lateral walls 7. This holding can be provided by means of bracket structures provided in the plate-like separation unit 6 and by means of similar structures like bracket and wall protrusions provided at inner lateral walls 7.

With reference to FIG. 2, the plate-like separation unit 6 has the base plate 8 which is essentially planar and whereon foods can be placed. The base plate 8 has an upper planar surface 10 whereon the foods are placed, and a lower planar surface 9 at the opposite side of the upper planar surface 10. There is the first bracket part 11 and the second bracket part 12 extending essentially in parallel direction with respect to each other at sides of the base plate 8 which are opposite to each other. The bracket parts 11, 12 are provided to extend essentially in the depth direction y. The bracket parts 11, 12 can be connected to the upper planar surface 10 by means of an adhesive element, for instance, by means of a liquid-based adhesive or a double-sided band not shown in the drawings. The bracket parts 11, 12 provide holding of the plate-like separation unit 6 to the inner lateral walls 7. There is a front panel 13 at a front side of the plate-like separation unit 6 which faces the front opening 4. The front panel 13 has a panel part 14 provided essentially at an orthogonal plane to the base plate 8. There are front panel connection tools 47 at an inner side of the panel part 14 which faces the base plate 8. Moreover, as shall be seen in FIG. 2, there is also a module carrier assembly 15 configured to carry a function module, particularly a light module in the plate-like separation unit 6. The module carrier assembly 15 is positioned so as to be close to the front panel 13 and so as to be connected to the lower planar surface 9. The module carrier assembly 15 is configured to extend in the width direction x of the plate-like separation unit 6, substantially along the whole width of the plate-like separation unit 6. The module carrier assembly 15 extends at a specific depth in the depth direction y of the plate-like separation unit 6.

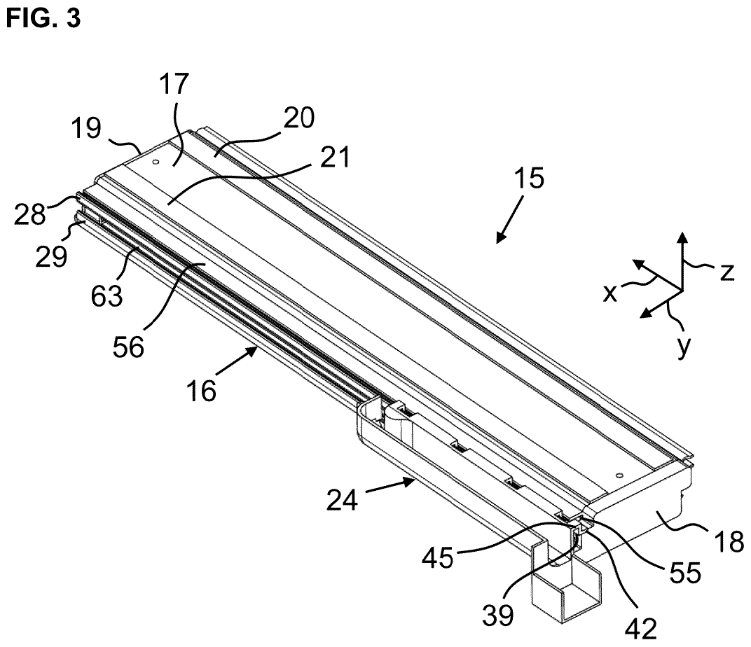

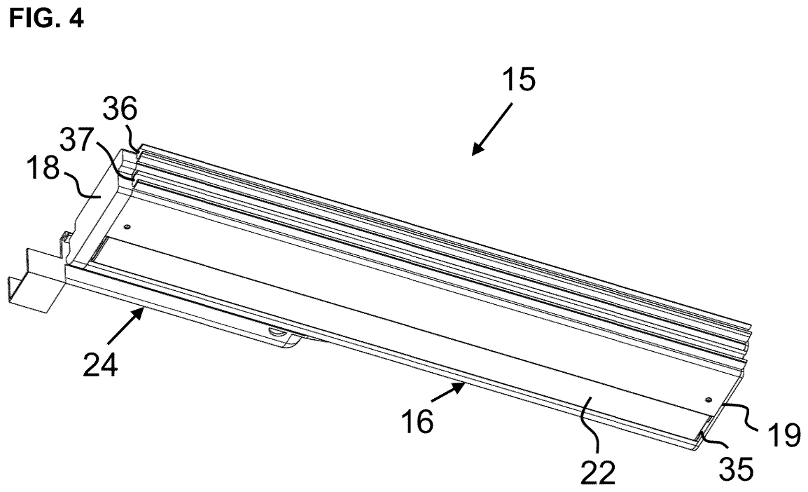

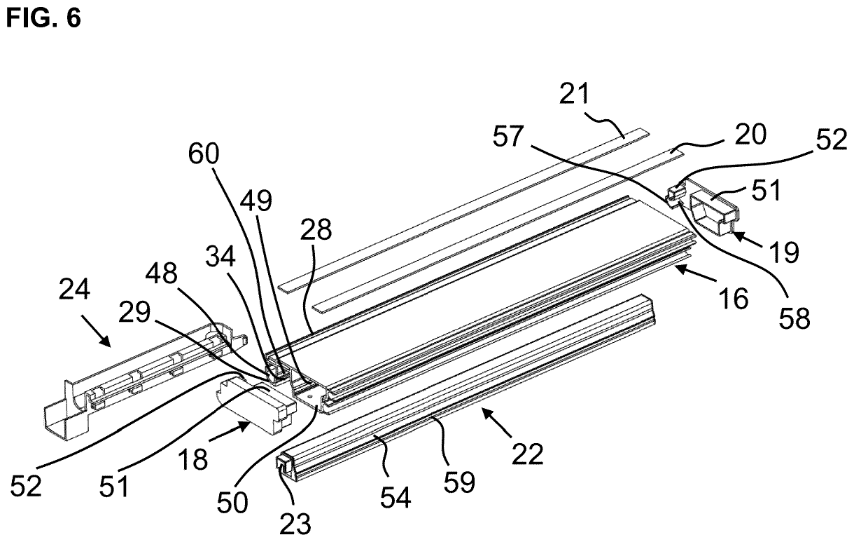

With reference to FIGS. 3 and 4, the module carrier assembly 15 essentially contains a module carrier body 16, an auxiliary carrier element 24, a light module 22, a first end cap 18 and a second end cap 19. The module carrier body 16 can essentially have a profile structure configured such that the light module 22, the auxiliary carrier element 24, the end caps 18, 19 and the front panel 13 are fixed and in a manner carrying these elements. In order to fix the module carrier assembly 15 to the lower planar surface 9 of the base plate 8, there is at least one adhesive element 20, 21 provided between the lower planar surface 9 and a module carrier planar surface 17 of the module carrier body 16 facing the lower planar surface 9. The adhesive elements 20, 21, also shown in FIG. 6, can be the module carrier planar surface 17 from one side and can be a band element, particularly a double-sided band element which can be adhered to the lower planar surface 9 from the other side. On the module carrier planar surface 17, preferably a first adhesive element 20 and a second adhesive element 21 are provided in a distanced manner to each other and in a manner extending in the width direction x. As shall be seen in FIG. 4, there are snap-fit claws 36, 37 at a front side of the module carrier body 16 facing the front panel 13. In more details, at the front side of the module carrier body 16, there is a first snap-fit claw 36 and a second snap-fit claw 37 embodied such that the front panel 13 is retained. The snap-fit claws 36, 37 are shaped and dimensioned such that the corresponding front panel connection tools 47, provided on the front panel 13, are at least partially received and held. Preferably, the snap-fit claws 36, 37 essentially has a form which is similar to C-shape. The front panel connection tools 47 have a form which is essentially similar to cylindrical form in a manner corresponding to the snap-fit claws 36, 37. The snap-fit claws 36, 37 preferably extend in the width direction x of the module carrier body 16. The front panel connection tools 47 preferably extend in the width direction x of the front panel 13.

As shall be seen in FIG. 3, the module carrier assembly 15 contains an external auxiliary carrier element 24 which can be connected to the module carrier body 16 in a removable manner. The auxiliary carrier element 24 is configured to extend essentially in the width direction x of the module carrier assembly 15. The auxiliary carrier element 24 is provided in a manner holding to a rear side provided at the opposite side of the front side of the module carrier assembly 15 to which the front panel 13 is connected. In other words, the front panel 13 and the auxiliary carrier element 24 are positioned at opposite sides of the module carrier body 16. The module carrier body 16 has at least one holding wall 28, 29 embodied such that the auxiliary carrier element 24 can hold. In more details, the module carrier body 16 has a first holding wall 28 and a second holding wall 29 extending in the width direction x. The holding walls 28, 29 are positioned in a distanced manner with respect to each other in a height direction z of the module carrier body 16. The holding walls 28, 29 are embodied such that there is an intermediate space 63 in between. The holding walls 28, 29 can have a form which is essentially similar to L-shape.

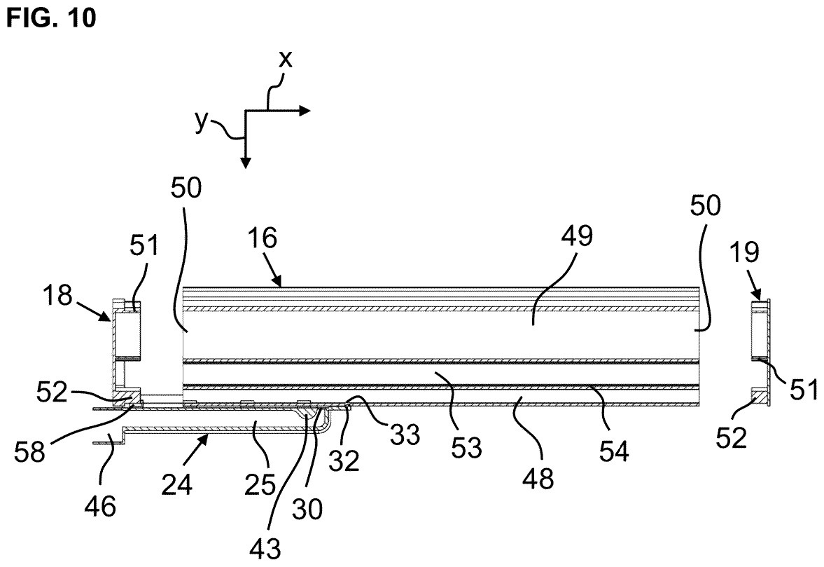

As shall be seen in FIGS. 4 and 6, the light module 22 is positioned in a light module channel 34 embodied in the module carrier body 16 and which essentially extends longitudinally. In other words, the module carrier body 16 has a longitudinal light module channel 34 arranged such that the light module 22 is positioned therein. At a lower side of the module carrier body 16, there is a longitudinal lower opening 35 that is opened to the light module channel 34. The light module 22 has a light module casing 54 that exists at the outermost part. Inside the light module casing 54, as shall be seen in the cross-sectional view as in FIG. 10, there is the circuit board which has a light source 53 that extends longitudinally. There can be pluralities of light source elements, particularly light emitting diodes LED through the circuit board which has light source 53. The electrical connection with the circuit board which has the light source 53 provided in the light module casing 54 is provided from a socket input 23 provided on the light module casing 54. The socket input 23 is embodied at an end part of the light module casing 54. The light module casing 54 is shaped and dimensioned in a manner placing to the light module channel 34. There is at least one light module casing connection housing 59 on the light module casing 54. The light module casing connection housing 59 extends longitudinally on the light module casing 54. Preferably, at least one couple of light module casing connection housing 59 is embodied at the opposite sides of the light module casing 54. In the light module channel 34, there are longitudinal module carrier body connection beams 60 embodied in a manner corresponding to the light module casing connection housing 59. When the light module 22 is slid and driven inside the light module channel 34, the module carrier body connection beams 60 are placed to the light module casing connection housings 59, and by means of this, the light module 22 is retained in the light module channel 34. In the invention, the light module channel 34 that exists on the module carrier body 16 is arranged at a region between the side where the holding walls 28, 29 exist, and a module carrier body channel 49. The module carrier body channel 49 is embodied as a longitudinal channel which is adjacent to the light module channel 34 of the module carrier body 16 and which essentially extends in a parallel manner to the light module channel 34.

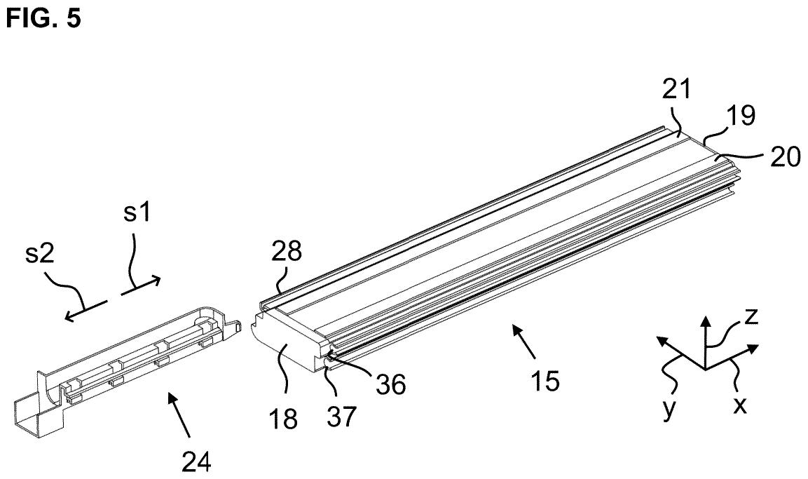

As shall be seen in FIG. 3 and FIG. 5, the auxiliary carrier element 24 is configured to provide sliding thereof in a sliding direction s1, s2 in the width direction x. In order to provide sliding of the auxiliary carrier element 24 on the holding walls 28, 29, the auxiliary carrier element 24 is arranged to extend along the width direction x of the holding walls 28, 29. When the auxiliary carrier element 24 is slid and moved at a first sliding direction s1, it moves on the holding walls 28, 29 and is finally connected to the module carrier body 16. When the auxiliary carrier element is moved in a second sliding direction s2, it again moves by sliding on the holding walls 28, 29, and finally, it completely separates from the module carrier body 16.

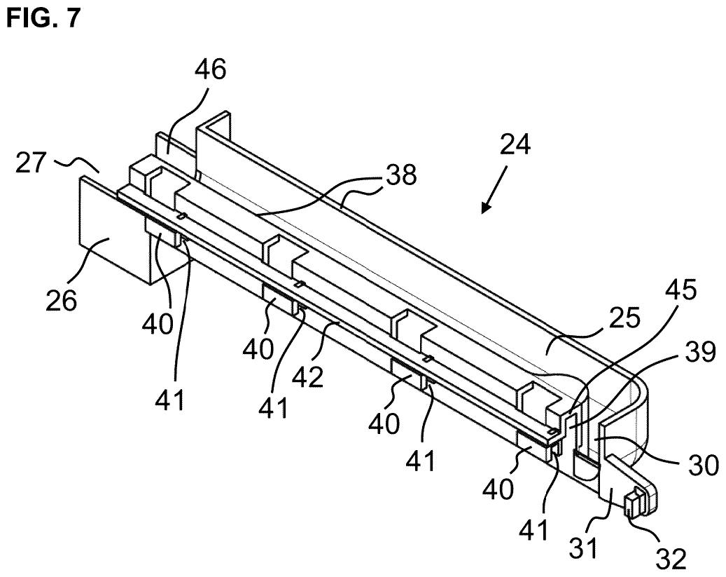

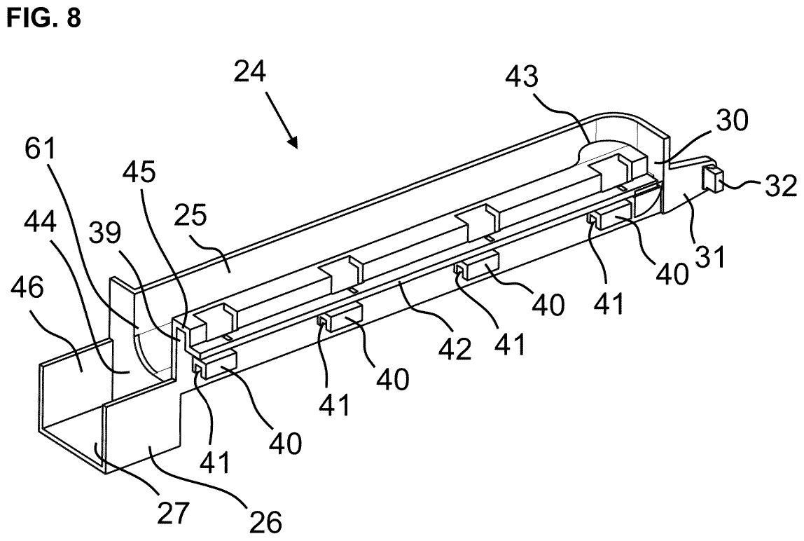

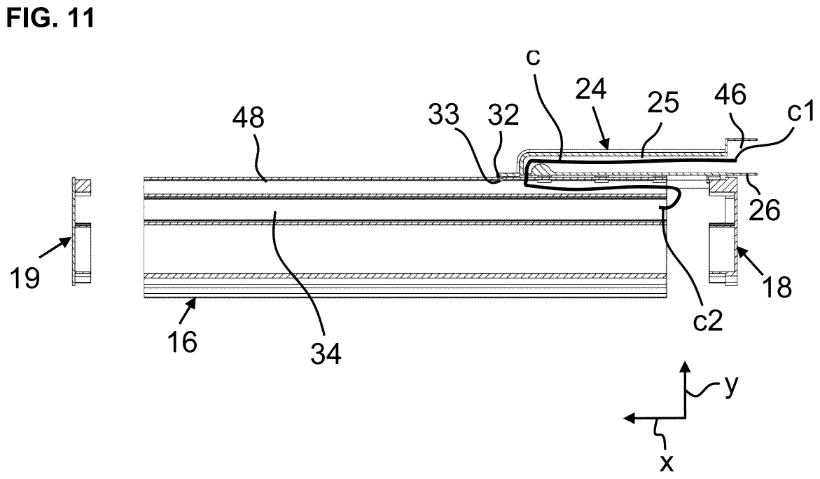

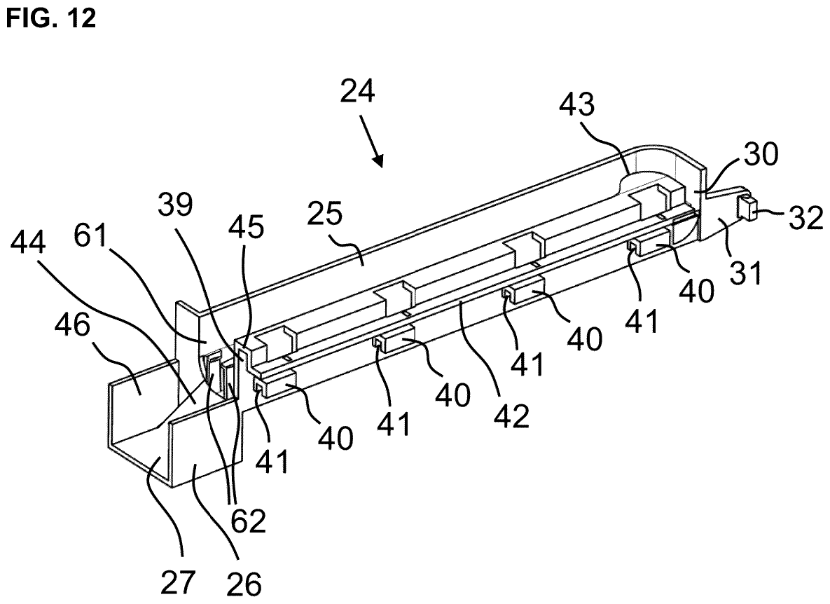

With reference to FIGS. 7 and 8, the auxiliary carrier element 24 contains a longitudinal channel 25 through which at least one light module cable c passes. The longitudinal channel 24 is defined by the mutual lateral walls 38 of the auxiliary carrier element 24. A base part of the longitudinal channel 25 can be inclined in a manner guiding the light module cable c. The longitudinal channel 25 has a cable passage opening 30 opened to the module carrier body 16 from one side. The longitudinal channel 25 can preferably have a form which is essentially similar to L-shape. The auxiliary carrier element 24 contains a connection extension 31 which essentially extends in a parallel direction in accordance with the sliding direction s1, s2 where the auxiliary carrier element 24 is slid on the holding walls 28, 29. As shall be seen in FIGS. 11 and 12, the connection tab 32 is provided in a manner corresponding to a connection housing 33 provided on the module carrier body 16 in a condition where the auxiliary carrier element 24 is connected to the module carrier body 16. By means of this, the auxiliary carrier element 24 is fixed to the module carrier body 16 at the desired position, and after the auxiliary carrier element 24 is assembled to the module carrier body 16, the undesired probable displacements are prevented. On the other hand, when the auxiliary carrier element 24 is connected to the module carrier body 16, the cable passage opening 30 corresponds to the intermediate space 63. By means of this, as shall be seen in FIG. 11, passage of the light module cable c, which passes through the longitudinal channel 25, to the cable passage channel 48 that exists in the module carrier body 16 is provided.

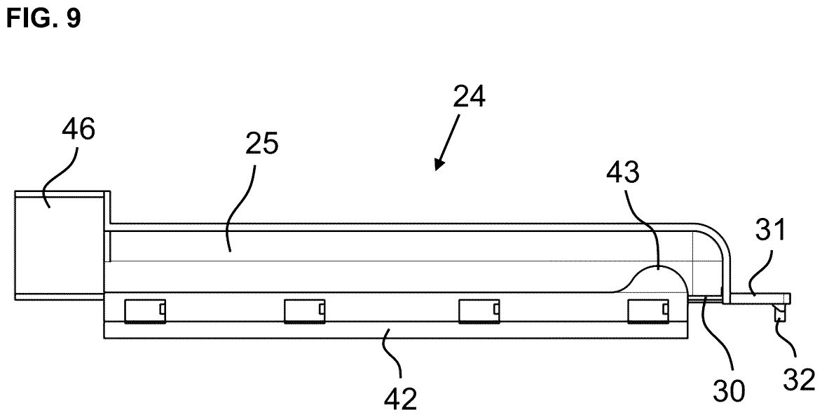

As described before and as shall be seen in FIG. 3, the module carrier body 16 has holding walls 28, 29 embodied such that the auxiliary carrier element 24 can be held at a side which is adjacent to the light module channel 34. Again with reference to FIGS. 7 and 8, the auxiliary carrier element 24 has holding channels 39, 41 provided in a manner corresponding to the holding walls 28, 29. The auxiliary carrier element 24 comprises a channel defining wall 45 embodied to define the first holding channel 39. The first holding channel 39 is configured to hold to the first holding wall 28 which exists in the module carrier body. In other words, at least one part of the first holding wall 28 engages to the first holding channel 39. The channel defining wall 45 also has the horizontal connection extension 42 provided in a manner engaging to a longitudinal connection channel 55 embodied on the module carrier body 16 and in a manner sliding in the connection channel 55 in a case where the auxiliary carrier element 24 is moved in the sliding direction s1, s2. A condition where the horizontal connection extension 42 engages to the connection channel 55 is seen in FIG. 3. The connection channel 55 is defined by a body horizontal extension 56 which essentially extends in the width direction x. The channel defining wall 45 and the horizontal connection extension 42 are embodied to extend essentially in the width direction x of the auxiliary carrier element 24 and the module carrier body 16. The horizontal connection extension 42 also increases the rigidity of the lateral wall of the auxiliary carrier element 24. In other words, the auxiliary carrier element 24 has a support function for the lateral wall. As shall be seen in FIG. 7 and FIG. 8, there is also at least one second holding channel 41 on the auxiliary carrier element 24. Preferably, there can be more than one second holding channel 41 on the auxiliary carrier element 24. The second holding channels 41 are defined by the holding tools 40. Preferably, more than one holding tool 40 is embodied to be positioned in a distanced manner with respect to each other in the width direction x such that each holding tool 40 defines the second holding channel 41. The second holding channels 41 are configured to hold to the second holding wall 29 that exists in the module carrier body 16. In other words, at least one corresponding related part of the second holding wall 29 engages into the second holding channels 40. Here, the second holding wall 29 is configured to define a cable passage channel 48 for reaching of the light module cable c which passes through the cable passage opening 30, to the light module channel 34. As shall be seen in FIGS. 10 and 11, the light module cable c, which passes through the cable passage opening 30 and through the intermediate space 63, reaches the cable passage channel 48 defined by the second holding wall 29. On the other hand, as shall be seen in FIGS. 8 and 9, the auxiliary carrier element 24 also comprises a bulged wall part 43 which is adjacent to the cable passage opening 30 and which is in bulged structure and provided in a manner guiding the light module cable c to the cable passage opening 30. The bulged wall part 43 is embodied to realize a bulge towards the longitudinal channel 25. By means of this, the bulged wall part 43 has been formed in a manner narrowing the part of the longitudinal channel 25 which is close to the cable passage opening 30. This facilitates the movement of the light module cable c inside the longitudinal channel 25 after the auxiliary carrier element 24 is assembled to the light module body 16.

As shall be seen in FIGS. 7 and 8, the auxiliary carrier element 24 has a casing part 26 embodied such that an electrical socket not shown in the drawings can be placed to which an end of the light module cable c is connected. The casing part 26 exists at a side which is opposite to the side where the connection extension 31 which has the connection tab 32 is existing. In other words, the casing part 26 is embodied at a side where a channel input 61 is existing where the light module cable c enters the longitudinal channel 25 of the auxiliary carrier element 24. As shall be seen in FIG. 11, electrical socket is connected to a first end part c1 of the light module cable c. The electrical socket is positioned at the casing part 26. A casing space 46 is defined such that the electrical socket shall be positioned inside the casing part 26. The casing part 26 is essentially embodied in a box form such that a front part and an upper part are open. There is a casing opening 27 at the front part of the casing part 26. As shall be seen in FIG. 8, a base part where the electrical socket is seating in the casing part 26 is embodied so as to be lower in a height direction z with respect to the longitudinal channel 25. In other words, there is a height difference between the casing part 26 and the longitudinal channel 25. Thanks to this height difference, a socket casing wall 44 is defined. The socket casing wall 44 functions as a stopper for the electrical socket, and is embodied to prevent entering of the electrical socket into the longitudinal channel 25 in an undesired manner. This aim is obtained by resting the electrical socket to the socket casing wall 44.

With reference to FIGS. 4-6, the end caps 18, 19 are retained to a module carrier body channel input 50 of the module carrier body 16 in a manner providing at least partially covering of the mutual lateral parts of the module carrier body 16. In more details, in the module carrier assembly 15, there are end caps 18, 19 which can be retained in a removable manner to the mutual end parts of the module carrier body channel 49 from one side and of the cable passage channel 48 from the other side and shaped and dimensioned in a manner providing at least partially covering the mutual end parts of the module carrier body 16. In other words, there is a first end cap 18 provided in a manner at least partially covering a first end part of the module carrier body 16, and a second end cap 19 provided in a manner at least partially covering a second end part of the module carrier body 16. At each of the end caps 18, 19, first end cap retaining tools 51 are embodied on the surfaces of the module carrier body 16 facing the related end parts. The first end cap retaining tools 51 are shaped and dimensions in a compliant manner to the module carrier body channel 49. The first end cap retaining tools 51 are arranged in a manner protruding from the surfaces thereof which faces the related end parts of the module carrier body 16. The first end cap retaining tools 51 are retained to the related module carrier body channel input 50 of the module carrier body channel 49, see FIG. 10. On the other hand, in each of the end caps 18, 19, on the surfaces facing the related end parts, there is also the second end cap retaining tools 52. The second end cap retaining tools 52 are retained to the related end part of a cable passage channel 48 defined by the second holding wall 29, see FIG. 10. Each of the end caps 18, 19 also comprises a curved extension 57 shaped and dimensioned in accordance with the second holding wall 29 and the cable passage channel 48. The curved extension 57 essentially has a form which is similar to C-shape. In a condition where the related end cap 18, 19 is retained to the related end part of the cable passage channel 48, at a side of the curved extension 57 facing the light module channel 34, there is a lateral opening 58 provided for reaching the light module cable c to the light module channel 34. Thanks to this lateral opening 58, the light module cable c which passes through the cable passage channel 48 exits the cable passage channel 48 thanks to the lateral opening 58, and the light module cable c reaches the light module channel 34. There is an electrical connector not shown in the drawings at a second end part c2 of the light module cable c which reaches the light module channel 34. The electrical connector is connected to the socket input 23 of the light module 22. By means of this, the electrical energy required for operation of the light module 22 is carried to the light module 22 by means of the light module cable c.

For exemplification, in FIG. 12, an isometric view related to another embodiment of the auxiliary carrier element 24 is given. In FIGS. 3-11, there are drawings where the first embodiment of the auxiliary carrier element 24 exists in the module carrier assembly 15. All explanations and descriptions, related to the abovementioned auxiliary carrier element 24, the first embodiment thereof and the module carrier assembly 15, are also valid for the second embodiment of the auxiliary carrier assembly 24 given in FIG. 12. The second embodiment of the auxiliary carrier element 24 basically has two differences from the first embodiment of the auxiliary carrier element 24. The first one of these is provided such that the socket casing wall 44 of the casing part 26 is inclined. By means of this, guidance of the light module cable c to the longitudinal channel 25 is facilitated. The second one of these is that there is at least one stopper extension 62 at the channel input 61 of the longitudinal channel 25. At the channel input 61, there are preferably couple of stopper extensions 62 positioned mutually to each other. The stopper extensions 62 are shaped and dimensioned in a manner allowing passage of the light module cable c but in a manner preventing passage of the electrical socket. The stopper extensions 62 can essentially have a form which is similar to L-shape. As the stopper extensions 62 are positioned at the channel input 61, a structure which is similar to M-shape is formed.

As seen in FIG. 11, the path followed by the light module cable c in the light module assembly 15 is mainly as follows: the first end part c1 of the light module cable c where the electrical socket exists is existing at the casing part 26. The light module cable c passes through the longitudinal channel that exists in the auxiliary carrier element 24, and is guided to the cable passage opening 30 thanks to the bulged wall part 43. Thanks to the intermediate space 63 which corresponds to the cable passage opening 30, the light module cable c which reaches the cable passage channel 48 passes through the cable passage channel 48 in a manner reaching the socket input 23 of the light module 22, namely it approaches towards the first end cap 18. Thanks to the lateral opening 58 that exists on the first end cap 18, the light module cable c which exits the cable passage channel 48 realizes a cycle and reaches the light module channel 34. Finally, the second end part c2 of the light module cable c where the electrical connector is provided is connected to the socket input 23 of the light module 22 that exists in the light module channel 34. By means of this, the route followed by the light module cable c between the casing part 26 and the socket input 23 is completed.

The following is a summary list of reference numerals and the corresponding structure used in the above description of the invention:
1 domestic cooling device
2 body
3 storage compartment
4 front opening
5 door
6 plate-like separation unit
7 inner lateral wall
8 base plate
9 lower planar surface
10 upper planar surface
11 first bracket part
12 second bracket part
13 front panel
14 panel part
15 module carrier assembly
16 module carrier body
17 module carrier planar surface
18 first end cap
19 second end cap
20 first adhesive element
21 second adhesive element
22 light module
23 socket input
24 auxiliary carrier element
25 longitudinal channel
26 casing part
27 casing opening
28 first holding wall
29 second holding wall
30 cable passage opening
31 connection extension
32 connection tab
33 connection housing
34 light module channel
35 longitudinal lower opening
36 first snap-fit claw
37 second snap-fit claw
38 lateral wall
39 first holding channel
40 holding tool
41 second holding channel
42 horizontal connection extension
43 bulged wall part
44 socket casing wall
45 channel defining wall
46 casing space
47 front panel connection tools
48 cable passage channel
49 module carrier body channel
50 module carrier body channel input
51 first end cap retaining tool
52 second end cap retaining tool
53 circuit board which has a light source
54 light module casing
55 connection channel
56 body lateral extension
57 curved extension
58 lateral opening
59 light module casing connection housing
60 module carrier body connection beam
61 channel input
62 stopper extension
63 intermediate space
s1 first sliding direction
s2 second sliding direction
c light module cable
c1 first end part
c2 second end part
x width direction
y depth direction
z height direction

1. A domestic cooling device, comprising:
a body;
a storage compartment encircled by said body and where foods to be cooled are placed;
at least one light module cable; and
a plate-shaped separation unit disposed in a removable manner in said storage compartment for separation of a volume of said storage compartment, said plate-shaped separation unit having a planar base plate and a module carrier assembly configured to carry a function module being a light module on said plate-shaped separation unit, said module carrier assembly having a module carrier body with a longitudinal light module channel disposed such that said light module is positioned therein, and an external auxiliary carrier element embodied in a manner providing passage of said at least one light module cable carrying electricity to said light module, and said external auxiliary carrier element being connected to said module carrier body in a removable manner.

2. The domestic cooling device according to claim 1, wherein said auxiliary carrier element has a longitudinal channel which has a cable passage opening formed therein and through which said at least one light module cable passes and which is opened to said module carrier body from one side.

3. The domestic cooling device according to claim 2, wherein said module carrier body has holding walls and at least one of said holding walls is embodied such that said auxiliary carrier element is held at a side which is adjacent to said longitudinal light module channel, and said external auxiliary carrier element has holding channels provided in a manner corresponding to said holding walls.

4. The domestic cooling device according to claim 3, wherein said external auxiliary carrier element is disposed in a manner extending along a width direction of said holding walls, in order to provide sliding thereof in a sliding direction on said holding walls.

5. The domestic cooling device according to claim 4, wherein:
said module carrier body having a connection housing; and
said external auxiliary carrier element has a connection extension which extends in a parallel direction with respect to the sliding direction where said external auxiliary carrier element is slid on said holding walls, and in a case where said external auxiliary carrier element is connected to said module carrier body and extending on said connection extension generally in an orthogonal direction to said connection extension, there is a connection tab provided in a manner corresponding to said connection housing of said module carrier body.

6. The domestic cooling device according to claim 4, wherein:
said module carrier body having a longitudinal connection channel formed therein; and
said external auxiliary carrier element has a channel defining wall embodied in a manner defining a first of said holding channels, and said channel defining wall has a horizontal connection extension provided in a manner engaging to said longitudinal connection channel embodied on said module carrier body, and in a manner sliding in said longitudinal connection channel in a condition where said external auxiliary carrier element is moved in the sliding direction.

7. The domestic cooling device according to claim 3, wherein:
said holding walls include a first holding wall and a second holding wall; and
said second holding wall is configured to define a cable passage channel for reaching of said at least one light module cable, which passes through said cable passage opening, to said longitudinal light module channel, and there is an intermediate space in a manner corresponding to said cable passage opening between said first holding wall and said second holding wall for reaching of said at least one light module cable to said cable passage channel through said longitudinal channel.

8. The domestic cooling device according to claim 2, wherein said external auxiliary carrier element has a bulged wall part which is adjacent to said cable passage opening and provided in a manner for guiding said at least one light module cable to said cable passage opening.

9. The domestic cooling device according to claim 5, wherein said external auxiliary carrier element has a casing part provided at a side which is opposite to a side where said connection extension which has said connection tab exist, and said casing part is embodied such that an electrical socket to which an end of said at least one light module cable is connected can be placed.

10. The domestic cooling device according to claim 9, wherein said casing part contains a socket casing wall provided such that said electrical socket, to which said end of said at least one light module cable is connected, can be rested.

11. The domestic cooling device according to claim 9, further comprising at least one stopper extension embodied at a channel input of said longitudinal channel which is adjacent to said casing part and shaped and dimensioned in a manner allowing passage of said at least one light module cable but in a manner preventing passage of said electrical socket.

12. The domestic cooling device according to claim 7, wherein said module carrier body has a longitudinal module carrier body channel which is adjacent to said light module channel and which extends generally parallel to said longitudinal light module channel.

13. The domestic cooling device according to claim 12, further comprising end caps disposed in said module carrier assembly, said end caps being retained in a removable manner to mutual end parts of said longitudinal module carrier body channel from one side and of said cable passage channel from another side and shaped and dimensioned in a manner providing at least partially covering said mutual end parts of said longitudinal module carrier body channel.

14. The domestic cooling device according to claim 13, wherein;
each of said end caps contains a curved extension shaped and dimensioned in accordance with said cable passage channel, and in a condition where said end caps are retained to a related end part of said cable passage channel; and
at a side of said curved extension facing said light module channel, there is a lateral opening formed therein and provided for extending said at least one light module cable to said light module channel.

15. The domestic cooling device according to claim 1, further comprising at least one adhesive element, wherein in order to fix said module carrier assembly to a lower planar surface of said planar base plate, said at least one adhesive element is disposed between said lower planar surface and a module carrier planar surface of said module carrier body facing said lower planar surface.
